(19) United States
(12) Patent Application Publication
(10) Pub. No.: US 2014/0072896 A1
(43) Pub. Date: Mar. 13, 2014

(54) MULTIPLE INJECTION FUEL CELL AND OPERATING METHOD THEREOF

(71) Applicant: Jean-Philippe Poirot-Crouvezier, St Georges De Commiers (FR)

(72) Inventor: Jean-Philippe Poirot-Crouvezier, St Georges De Commiers (FR)

(73) Assignee: Commissariat A L'Energie Atomique Et Aux Energies Alternatives, Paris (FR)

(21) Appl. No.: 14/116,725

(22) PCT Filed: May 2, 2012
(86) PCT No.: PCT/EP2012/058012

§ 371 Date: Nov. 14, 2013

(30) Foreign Application Priority Data
May 9, 2011 (FR) 1153955

(51) Int. Cl. H01M 8/04

(52) U.S. Cl. CPC H01M 8/04201; H01M 8/04753
USPC 429/444; 429/459

(57) ABSTRACT

Fuel cell batteries are provided, and in particular hydrogen fuel cell batteries composed of at least one stack of cells. The battery is divided into at least two groups of cells able to be supplied with hydrogen separately. In a first phase, only the first group of cells and not the second is supplied; unconsumed hydrogen may however flow between the two groups via at least one evacuation manifold connected to the cells of the two groups. In a second phase, the supply to the two groups is reversed, unconsumed hydrogen still being able to flow between the two groups via the evacuation manifold. In a third phase, after a series of alternations of the two first phases, the two groups are first simultaneously supplied, then a purge valve of the evacuation manifold is opened then closed.

The invention relates to fuel cell batteries, and in particular hydrogen fuel cell batteries.

A fuel cell battery is a stack of elementary cells in which an electrochemical reaction takes place between reactants that are gradually introduced as the reaction consumes them. The fuel, which is hydrogen in the case of a hydrogen fuel cell battery, is brought into contact with the anode; the oxidant, oxygen or air for a hydrogen fuel cell battery, is brought into contact with the cathode. The anode and cathode are separated by an electrolyte, possibly a solid membrane, that is permeable to certain of the constituents of the reaction but not all. The reaction is subdivided into two half reactions (an oxidation and a reduction), which take place, on the one hand, at the anode/electrolyte interface, and on the other hand, at the cathode/electrolyte interface. In practice, the solid electrolyte is a membrane that is permeable to hydrogen ions H⁺ but not to molecular dihydrogen H₂ or electrons. The reduction reaction at the anode is oxidation of hydrogen producing H⁺ ions, which pass through the membrane, and electrons, which are collected by the anode; at the cathode these ions participate in the reduction of oxygen, requiring electrons and producing water, heat also being given off.

The stack of cells is only the location of the reaction: the reactants must be supplied thereto, and products and non-reactive species must be evacuated therefrom, just like the heat produced. Lastly, the cells are connected in series to one another, the anode of one cell being connected to the cathode of the adjacent cell; at the ends of the stack of cells, on one side an anode is connected to a negative terminal in order to evacuate electrons, and on another side a cathode is connected to a positive terminal. An external circuit is connected to these terminals. Electrons flow from the anode to the cathode via the external circuit thus powered by the battery as the electrochemical reaction progresses.

A fuel cell battery may be divided into a plurality of stacks each having electrical terminals and interfaces for the supply of reactive fluids and coolants; these subassemblies are then connected in parallel or in series, from the fluidic point of view and from an electrical point of view. With respect to the fluidic connection a parallel connection is by far that which is most frequently encountered.

In systems using hydrogen and atmospheric air as reactants, compressed air is delivered to the battery and passes through a series of components (filter, heat exchanger, humidifier, etc.) before penetrating into the battery on the cathode side. At the cathode outlet, the air is generally dried in order to recover the water necessary for the humidification, then most often evacuated via a back-pressure regulator (i.e. a regulator of upstream pressure) allowing the pressure of the line to be maintained. On the anode side, the hydrogen may be obtained from a large number of different sources, for example a pressurized tank allowing recourse to a device for compressing the gas to be avoided. It is therefore most often delivered to the battery after having passed through a simple pressure reducing valve or a solenoid valve applying the expected pressure in the line. Most of these possible sources deliver dry hydrogen.

At the battery outlet, a number of scenarios are possible: hydrogen injected into the battery and not consumed by the reaction may in part be reinjected at the battery inlet together with dry hydrogen originating from the source, in order to homogenize the mixture in the battery i.e. in order to mix it with the reaction products and non-reactive species present (notably nitrogen, coming from the cathode via permeation through the membrane) which do not participate in the reaction and on the contrary tend to inhibit it; this recirculation in addition makes it possible to maintain a certain humidification of the hydrogen that reaches the cells; specifically, in the reaction products, there is water vapor mixed with unconsumed hydrogen, and this water vapor is recirculated with the hydrogen; humidification is desirable in order to make the hydrogen less aggressive with respect to the electrolytic membrane. However, the recirculation systems that enable this reinjection are complex and expensive.

Alternatively, the cells can be purged at regular intervals in order to evacuate the products of the reaction, and notably nitrogen. However, it is not possible to wait until there is too much nitrogen in the cells before purging because the electrochemical reaction would stop. Purging of products that have become a hindrance cannot take place without, at the same time, purging a certain amount of hydrogen; this is a disadvantageous loss because of the cost of the hydrogen, and it is desirable to minimize the amount of hydrogen thus purged.

One of the aims of the invention is to provide a system that reduces losses of reactant (notably hydrogen) during purges, without however requiring a complex recirculation system.

According to the invention, a fuel cell battery is provided producing electrical power via an electrochemical reaction between at least two reactants, the battery comprising at least one stack of cells each of which is composed of an assembly of an electrolyte, an anode, and a cathode, the stack being provided with a means for supplying at least one of the reactants, this means being able to deliver this reactant to the cells of the stack, and a means for evacuating sub-products of the reaction, characterized in that:

the cells of the battery are divided into N groups, N being an integer >1, and the means for supplying the reactant comprises a respective supply manifold for supplying each group of cells, this manifold being able to deliver the reactant selectively to the cells of a group without delivering it to the cells of the other groups,

the supplying means comprises a selective switching means for permitting and preventing the passage of the reactant to each of the manifolds,

the evacuating means comprises one or more evacuation manifolds, it is arranged in order to permit reactant not consumed by the reaction to flow between the N groups of cells, and it comprises a purge valve.

The cells of the various groups are preferably stacked in an interleaved way, which is to say that a cell of one group is adjacent a cell of another group in one and the same stack. It is also possible to envisage, but this configuration would be less advantageous because it is less compact, for the battery to be formed from a plurality of stacks each corresponding to a respective group of cells.

The evacuation manifold, passing through the stack of cells, is preferably common, i.e. the cells of all the groups communicate directly with this manifold; however, separate manifolds could also be provided for each group; they would then be connected to the outlet of the stack in order to ensure free flow from one group to the other.

The supplying means may supply hydrogen to the supply manifolds of the N groups, the manifold of a group communicating with the cells of this group from the anode side. However, provision may also be made for the supplying means to supply oxygen to the supply manifolds of the N groups, the manifold of a group communicating with the cells of this group from the cathode side.

Correspondingly, the invention provides a method for operating a fuel cell battery, which may be implemented with such a battery structure.

The method is a method for supplying a stack of cells of a fuel cell battery with at least one reactant, which is characterized in that N groups of cells of the stack are selectively supplied with the reactant in at least three phases,

a first phase in which a first group of cells is supplied but not a second group, the unconsumed reactant being able however to flow between the two groups via at least one evacuation manifold connected to the cells of the two groups;

a second phase in which the second group is supplied but not the first, the unconsumed reactant being able however to flow between the two groups via the evacuation manifold; and

a third, purging, phase in which the two groups are first supplied simultaneously, then a purge valve of the evacuation manifold is opened then closed.

The two first phases are preferably repeated in a plurality of successive alternations before the third phase is passed to, after which a cycle restarts.

If the number N is greater than two, the principle remains the same, but a third group, a fourth group, etc. are provided in the battery, and complementary phases are inserted in the process. Either a single group is supplied during a phase or a plurality (but not all) of the groups are supplied by modifying the composition of the groups supplied in each phase in a series of successive phases with a gradual permutation of the supplies. Next, a purge phase is carried out, which comprises simultaneously opening all the supplies, immediately followed by a common purge (opening then closing of the purge valve).

Because it is possible to make unconsumed reactant flow from one group of cells to another via the one or more evacuation manifolds, it is possible to reduce hydrogen consumption by purging the battery less often; specifically, certain groups of cells, but not all of them, are supplied simultaneously, the reaction continuing in the one or more groups that are not directly supplied; the risk of saturation of reaction products, which would tend to stop the electrochemical reaction by creating, locally, a shortage of reactant, is reduced by the mixing of reaction products achieved by the successive changes of supply, and by the fact that the reactant not consumed in a supplied group reaches the one or more unsupplied groups via the evacuation manifold, and mixes with the reaction products, allowing the reaction to continue. For example, in a hydrogen fuel cell battery using air as an oxidant, and generating nitrogen at the anode via permeation through the membrane, cells that have their main supply of hydrogen cut risk becoming saturated with nitrogen, but hydrogen not consumed by a group of (supplied) cells reaches the other (unsupplied) group via the one or more evacuation manifolds of the two groups. Mixing of the nitrogen resulting from the reaction in the cells of the unsupplied group takes place because of the change of supply, and this mixing is facilitated by the open connection between the outlets of the two groups. Even though this mixing supplies only a small percentage of hydrogen to the nitrogen saturated zones, the mixing and this small percentage are sufficient to sustain a correct reaction.

In addition, the hydrogen thus recovered is charged with moisture and introduces this moisture into the unsupplied group so that when this group is once more supplied the electrolytic membranes remain in the presence of a mixture of moist and dry hydrogen. This moisture has a beneficial effect on the lifetime of the membranes.

Other features and advantages of the invention will become apparent on reading the following detailed description that is given with reference to the appended drawings in which:

FIG. 1 schematically shows the principle of the architecture of a fuel cell battery according to the invention;

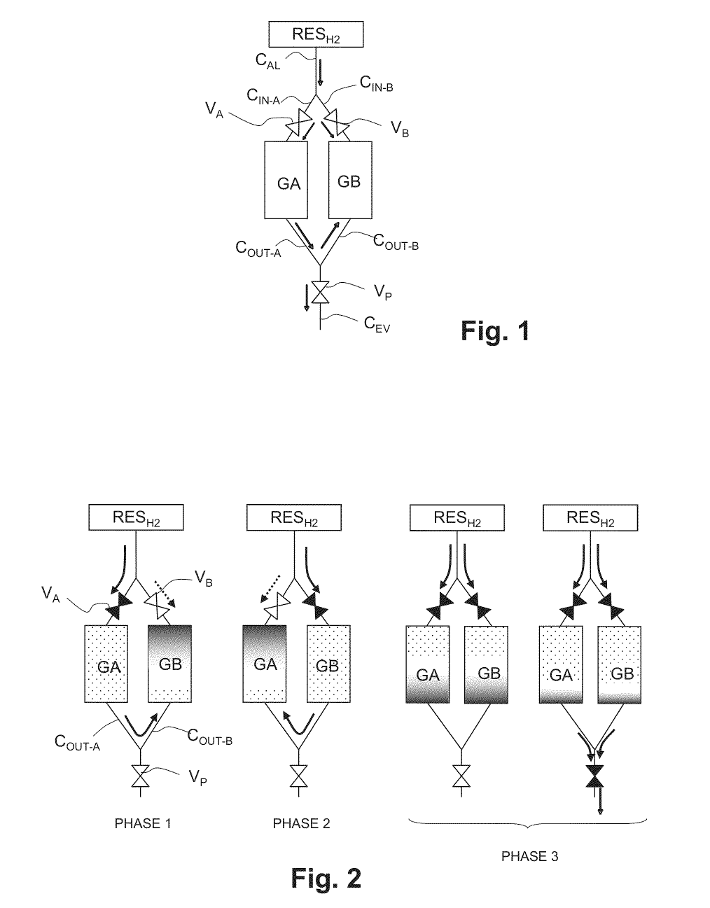

FIG. 2 shows the three operating phases of the battery in one implementation of the method according to the invention;

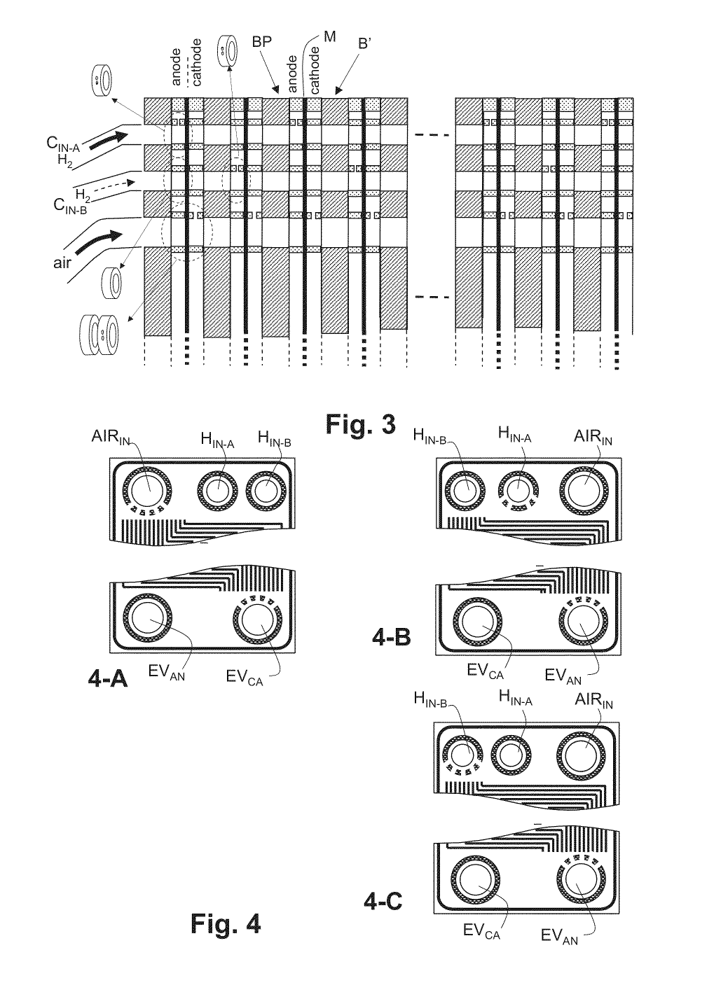

FIG. 3 shows a stack of cells belonging to two groups able to be supplied separately, in which the groups of cells are interleaved, two adjacent cells belonging to two different groups; and

FIG. 4 shows a schematic view of bipolar plates, in three different planes for the plates of stacked cells: the plane of the cells on the cathode side, the plane of a cell of a first group on the anode side, and the plane of a cell of a second group on the anode side.

The invention will be described with regard to a hydrogen fuel cell battery supplied on the anode side with hydrogen and on the cathode side with air, the implementation of the method being applied here to the hydrogen, i.e. to the anode side. The invention is also applicable to the cathode side, i.e. to the supply of oxidant, when the latter consists mainly of oxygen (content higher than 50% in the dry gas). Lastly, the invention is mainly applicable to hydrogen fuel cell batteries but it is also applicable to other reactants, whether on the side of the supply of oxidant or on the side of the supply of fuel.

The hydrogen fuel cell battery comprises multiple cells each comprising an anode, a cathode and an electrolyte between the anode and cathode. Here, only the case where the electrolyte consists of an ion exchange membrane will be considered. In practice, many cells are stacked to form one or more stacks that are connected together from a fluidic and electrical point of view.

A means for supplying the cells with pressurized hydrogen is provided. It comprises means for distributing hydrogen in the interior of each cell on the anode side. Likewise, a means for supplying air is provided, with means for distributing air in each cell on the cathode side. Again likewise, a means for evacuating the products of the reaction (nitrogen, water and notably liquid water) is provided, this means being distributed in order to gather and evacuate the reaction products from all the cells. Here, attention will only be given to the evacuation of reaction products and inert species from the anode side, in particular the water and the nitrogen that initially appear on the cathode side but that are passed to the anode side through the electrolytic membrane. Finally, cooling means distributed over all the cells may also be provided for fuel cell batteries that require such cooling.

FIG. 1 shows, very schematically, two groups of cells: group GA and group GB, with an upstream part (upstream of the stack of cells) of the means for supplying hydrogen, and a downstream part (downstream of the stack of cells) of the evacuating means. The other elements described above are not shown.

The two groups of cells are identical but are supplied separately. The upstream part of the supplying means therefore comprises:

a tank RES_{H2} of pressurized hydrogen (or any other means for delivering pressurized hydrogen);

a main general supply duct C_{AL} for supplying the battery, which duct delivers hydrogen from the tank;

two secondary inlet ducts C_{IN-A} and C_{IN-B} that deliver hydrogen from the general duct C_{AL} to each of the two groups of cells; the battery comprises, downstream of these secondary ducts, a respective supply manifold for each group; this manifold passes through the stack of cells and distributes the hydrogen in the cells; it is not shown in FIG. 1; and

switching valves, on the path of the hydrogen from the general duct, for directing the hydrogen either toward the supply manifold of the group GA or toward the supply manifold of the group GB or toward both at the same time; two separate valves V_{A} and V_{B} have been shown, each placed in a respective secondary duct, but it will be understood that a single three-position valve, placed at the junction between the main duct and the secondary ducts, could be used.

FIG. 1 shows, for the sake of comprehensibility, the two groups of cells one beside the other; in fact, the cells are all stacked and the groups of cells will be interleaved with one another in the stack: the stack will comprise a regular alternation of cells of group A and cells of group B, a cell of one group preferably always being adjacent a cell of the other group.

In order to evacuate the products of the reaction from the anode side, one or two evacuation manifolds (not shown) are provided, which manifolds pass through the stack of cells and gather, from each cell, the products generated by the reaction at the anode. Downstream of this manifold, the evacuating means may comprise one or two outlet ducts C_{OUT-A} and C_{OUT-B} (depending on whether there are one or two evacuation manifolds) which join a main evacuation duct C_{EV}. A purge valve V_{P} is provided in the main duct C_{EV}. It serves to purge nitrogen and water coming from the two groups of cells at the same time, i.e. the groups are not each purged separately.

To simplify the diagram and the explanation, FIG. 1 shows the cells of the two groups having separate manifolds, but in practice there will preferably be a single manifold connected to all the cells of the two interleaved groups.

FIG. 2 shows the main operating phases of the battery, with the same very simplified drawing of FIG. 1.

In a first phase, the valve V_{A} is open, the valve V_{B} is closed, and the valve V_{P} is closed; the group GA of cells is supplied with pressurized dry hydrogen via the valve V_{A}; the pressure pushes the reaction products, i.e. nitrogen, liquid water, and water vapor, but also hydrogen not consumed by the reaction before the valve V_{A} was opened, toward the outlet duct C_{OUT-A}. This (moist) hydrogen reaches the group GB via the duct C_{OUT-B}, which communicates freely with the duct C_{OUT-A} (or directly via the evacuation manifold common to the two groups if it exists); the moist hydrogen mixes with the products of the reaction that continues in the group GB not supplied with dry hydrogen. This mixing with a supply of hydrogen prevents local saturation of the reaction zone with too high a concentration of nitrogen; the electrochemical reaction may therefore continue during this phase despite the absence of a supply of dry hydrogen.

In the second phase, the situation is quite simply reversed, the valve V_{A} is closed and the valve V_{B} is opened. The valve V_{P} remains closed. The flow of reaction products and of unconsumed hydrogen reverses and passes from the duct C_{OUT-B} to the duct C_{OUT-A}.

These two phases may be followed by a third phase, or indeed be alternated X times before a third phase is carried out. During this alternation, the volume of accumulated nitrogen is moved from one group of cells to the other through the outlet ducts or via the common evacuation manifold. This mixing allows nitrogen stratification or local accumulation of nitrogen, which is continuously produced but not evacuated until the purge valve is opened, to be limited. In the absence of this mixing it would be necessary to purge often; with this mixing it is possible to purge less often.

The third phase is therefore a purging phase for simultaneously evacuating reaction products and notably nitrogen from the two groups of cells. The admission valves V_{A} and V_{B} are opened together, then the purge valve V_{P} is also opened, then closed.

The frequency at which the purging phase is carried out (X times lower than the frequency of the alternations in the supply of groups GA and GB) may be:

a fixed preset frequency;

a frequency set relative to the frequency of alternation of the two first phases (which itself may be fixed or variable);

a frequency varying as a function of battery operating parameters, for example current delivered or temperature; or

a frequency varying as a function of a delivered voltage threshold level, this threshold possibly itself varying as a function of the operating parameters of the battery.

The frequency of the alternation of the two first phases may either be set experimentally or in situ by detecting parameters such as the output voltage across the terminals of the cells: a voltage drop indicates that the reaction is slowing and therefore the usefulness of then switching the supply of the groups if this drop exceeds a tolerable threshold (for example a few tens of millivolts).

The same principle may be applied to more than two groups of cells supplied separately with hydrogen and having their evacuation outlets in communication with one other.

For example, there may be three groups and their supply may be changed in a three phase circular permutation that may be repeated X times before a fourth common purge phase:

phase 1: a group GA supplied, two groups GB and GC not supplied;

phase 2: a group GB supplied, two groups GC and GA not supplied;

phase 3: a group GC supplied, two groups GA and GB not supplied; and

phase 4, after X series of three permutations: Groups GA, GB and GC are supplied, and then the purge valve is opened then closed.

It is also possible to make provision for two groups to be supplied simultaneously, only one not being supplied.

If the number N of groups is increased above three, many other combinations are possible. For example, with four groups GA, GB, GC, GD, having outlets connected with a common purge valve, a four phase circular permutation could be used in which two groups are supplied simultaneously and two others are not supplied:

phase 1: two groups GA, GB supplied, two groups GC, GD not supplied;

phase 2: two groups GB, GC supplied, two groups GD, GA not supplied;

phase 3: two groups GC, GD supplied, two groups GA and GB not supplied;

phase 4: two groups GD, GA supplied, two groups GB, GC not supplied; and

phase 5, after X series of four permutations: Groups GA, GB, GC and GD are supplied, and then the purge valve is opened then closed.

Better mixing of the nitrogen is then assured, the nitrogen being transferred more frequently from one group of cells to another.

The method steps thus described are particularly advantageous when the hydrogen fuel cell battery functions with air as an oxidant since they make it possible to avoid drawbacks due to nitrogen. However, even if the oxidant does not contain nitrogen, the mixing that results from this method is advantageous for limiting drying of the membrane at the inlet of the fuel cell battery, on the anode side.

To implement the invention, the departure point is a conventional arrangement of stacked cells, but this arrangement is adapted in order to include therein distributing means capable of distributing the reactant, for example hydrogen, to certain cells but not to others.

Conventional fuel cell batteries comprising stacked cells comprise a superposition of what are called bipolar plates, between which are placed assemblies comprising, at the same time, an electrolytic membrane and an electrode on each side of the membrane. The bipolar plates, optionally associated with seals having a particular configuration, serve to collect electrical current and to distribute the reactant gases (hydrogen and air, or hydrogen and oxygen) to the membrane, on the appropriate side of the membrane: hydrogen on the anode side, air or oxygen on the cathode side. They comprise distribution channels facing the anodes and others facing the cathodes. On their periphery, the plates are pierced with apertures serving to deliver the reactant gases, and apertures serving to evacuate the products of the reaction. The apertures for delivering reactant gas form, via the superposition of plates in intimate contact with one another, manifolds for supplying reactant gas. The evacuation apertures form, in the same way, manifolds for evacuating the products of the reaction. Seals are provided so that the fluids remain confined in these manifolds, but the design of the bipolar plates and/or the seals is such that passages are formed in the manifolds in the locations where it is desired to distribute the fluid to a cell so that the fluid penetrates into this cell, on the desired side, without crossing to the other side. These passages direct the reactant gases to the cell via distribution channels formed in the plates, which distribute the gas as uniformly as possible over the electrolytic membrane.

The same applies to the reaction products, the plates and seals being designed in order to allow the reaction products to be gathered and evacuated, on the anode side and/or the cathode side, to the evacuation manifold.

Thus, the supply manifold for supplying a conventional cell with hydrogen consists of a stack of plates and seals designed such that the hydrogen can spread in the cells on the anode side, but absolutely not on the cathode side. The opposite is true for the supply manifold supplying air or oxygen.

At the end of the stack these apertures formed in the plates are respectively connected to a respective supply duct for supplying each reactant and an evacuation duct for evacuating the products of the reaction.

According to the invention, this structure is modified by drilling the plates with N supply manifolds (N being an integer at least equal to 2) for supplying the reactant for which it is desired to implement the invention, here N hydrogen supply manifolds are provided. Therefore, instead of designing the plates and seals with stacked apertures so that the hydrogen can penetrate into the supply manifold on the anode side of all the cells of the stack, provision is made:

for the plates and seals each to comprise N series of stacked apertures (N>1) instead of a single series, in order to form N supply manifolds instead of one, each manifold supplying a respective group of cells; and

for the plates and seals of the stack to have N different designs as regards the passages, allowing a gas to pass between a manifold of one series and a cell, so that the stacked apertures of a series supply the cells of the corresponding group but not the cells of the other groups.

Preferably, the cells are regularly alternated, i.e. two adjacent cells belong to different groups.

Therefore, the groups are differentiated by the fact that a cell belonging to one group is in communication with the supply manifold of this group but not in communication with the other supply manifolds that pass through it.

At the end of the stack, the apertures forming a respective hydrogen supply manifold are connected to respective supply ducts (C_{IN-A}, C_{IN-B}). There are N supply manifolds respectively connected to one of N ducts. Furthermore, valves such as V_{A}, V_{B} are provided in order to permit or prevent the injection of hydrogen into a respective duct, and therefore into a series of respective apertures forming a supply manifold.

As regards the apertures corresponding to the evacuation manifold (attention will be given only to the manifold of the anode reaction products, but the cathode may also be provided with a manifold), two possibilities may be envisioned:

either there is a single evacuation manifold formed by apertures in the superposed bipolar plates, this manifold communicating with all the cells whatever the group to which the cells belong; the cells may then directly communicate with one another via the evacuation manifold;

or a plurality of evacuation manifolds are provided (not necessarily N) configured as the supply manifolds, i.e. connected to certain cells but not others; in this case these manifolds are connected, at the end of the stack, to a plurality of evacuation ducts, as shown for the sake of simplicity in FIGS. 1 and 2: ducts C_{OUT-A}, C_{OUT-B}.

FIG. 3 shows a cross section through an example stack of a plurality of cells in a battery according to the invention. The cells are each composed of a central electrolytic membrane M, between two bipolar plates BP and BP′. For each membrane, the anode is on the left and the cathode is on the right. The plates shown are flat in order to simplify the drawing and only plate portions containing the supply manifolds, for supplying air and hydrogen (in principle at the periphery of the plates), have been shown. The evacuation manifolds are not shown. They may take the same form as the air supply manifolds. Cooling manifolds, which may optionally be present, have also not been shown.

Seals, notably completely impermeable peripheral seals, separate the membrane from each plate.

In the drawing in FIG. 3, the communication or lack of communication between an evacuation manifold and the cells is considered to be controlled by seals, for example ring joints, encircling the apertures in the location of the cell and on the (anode or cathode) side in question. A seal that continually encircles an aperture i.e. one that does not contain a communication aperture, prevents communication. An injector seal comprising communication apertures enables this communication.

It will be understood that the communication may be prevented or permitted by means other than these ring joints, for example seals of complex shape, or bipolar plates with particular designs.

If FIG. 3 is considered, it may be seen that the hydrogen supply manifold that is supplied by the duct C_{IN-A} is in communication with one cell in two on the anode side and never in communication with the cathode side. It may also be seen that the other supply manifold, supplied by the duct C_{IN-B}, is in communication with the other cells on the anode side and never in communication with the cathode side. The air supply manifold is in communication with all the cells on the cathode side, but never on the anode side.

FIG. 4 shows three views of bipolar plates again showing the arrangement with two hydrogen supply manifolds, each of the manifolds communicating with the cell of one group but not with that of the other group. In this example, there is one hydrogen supply manifold H_{IN-A} for the cells of group A, another H_{IN-B} for the cells of group B, an air supply manifold AIR_{IN} for all the cells, an evacuation manifold EV_{AN} for the anode-side products, and an evacuation manifold EV_{CA} for the cathode-side products.

The first view 4-A shows the front of the cathode-side bipolar plate, with:

an aperture representing the manifold AIR_{IN} and a seal provided with communication apertures;

two apertures representing the manifolds H_{IN-A} and H_{IN-B} with seals without apertures, communication therefore being prevented;

an aperture representing the evacuation manifold EV_{CA} for the cathode-side reaction products, with a seal drilled with apertures; and

an aperture representing the evacuation manifold EV_{AN} for the anode-side reaction products, with a seal without apertures.

The second view 4-B shows the front of an anode-side bipolar plate of a cell of group GA, with:

an aperture representing the manifold AIR_{IN} and a seal that contains no communication apertures;

an aperture representing the manifold H_{IN-A} with a seal provided with communication apertures;

an aperture representing the manifold H_{IN-B} with a seal that does not contain communication apertures;

an aperture representing the evacuation manifold EV_{AN} for the anode reaction products, with a seal drilled with apertures; and

an aperture representing the evacuation manifold EV_{CA} for the cathode reaction products, with a seal without apertures.

The third view 4-C shows the front of an anode-side bipolar plate of a cell of group GB, with:

an aperture representing the manifold AIR_{IN} and a seal that contains no communication apertures;

an aperture representing the manifold H_{IN-A} with a seal that does not contain communication apertures;

an aperture representing the manifold H_{IN-B} with a seal provided with communication apertures;

an aperture representing the evacuation manifold EV_{AN} for the anode reaction products, with a seal drilled with apertures; and

an aperture representing the evacuation manifold EV_{CA} for the cathode reaction products, with a seal without apertures.

To ensure selective distribution of hydrogen in one or other of the manifolds, the length of secondary ducts, such as C_{INA} and C_{INB}, may be minimized. Specifically, it is possible to produce a means for directing the gas in a terminal plate of the stack. These means may be valves but also, more simply, switchable shutters, or even perforated plates that are mounted to be rotatably or translatably moveable, in order to bring an aperture in the plate into communication with the duct to be supplied with minimum power consumption.

1. A fuel cell battery producing electrical power via an electrochemical reaction between at least two reactants, the battery comprising at least one stack of cells each of which is composed of an assembly of an electrolyte, an anode, and a cathode, the stack being provided with a means for supplying at least one of the reactants, this means being able to deliver this reactant to the cells of the stack, and a means for evacuating sub-products of the reaction:
wherein the cells of the battery are divided into N groups, N>1, and the means for supplying the reactant comprises a respective supply manifold for supplying each group of cells, this manifold being able to deliver the reactant selectively to the cells of a group without delivering it to the cells of the other groups,
wherein the supplying means furthermore comprises a selective switching means (V_{A}, V_{B}) for permitting and preventing the passage of the reactant to each of the manifolds, and
wherein the evacuating means comprises at least one evacuation manifold, it is arranged in order to permit reactant not consumed by the reaction to flow, between the N groups of cells, and it comprises a purge valve, and the cells of the various groups are stacked in an interleaved way in one and the same stack, which is to say that a cell of one group is adjacent a cell of another group in the stack.

2. The fuel cell battery as claimed in claim 1, wherein the evacuation manifold, passing through the stack of cells, communicates with the cells of all the groups.

3. The fuel cell battery as claimed in claim 1, wherein the supplying means supplies hydrogen to the supply manifolds of the N groups, the manifold of a group communicating with the cells of this group from the anode side.

4. The fuel cell battery as claimed in claim 1, wherein the supplying means supplies oxygen to the supply manifolds of the N groups, the manifold of a group communicating with the cells of this group from the cathode side.

5. A method for supplying a fuel cell battery, comprising at least one stack of cells, with at least one reactant, wherein N groups of cells of the battery, N>1, are selectively supplied with the reactant in at least three phases,
a first phase in which a first group of cells is supplied but not a second group, the unconsumed reactant being able however to flow between the two groups via at least one evacuation manifold connected to the cells of the two groups;
a second phase in which the second group is supplied but not the first, the unconsumed reactant being able however to flow between the two groups via the evacuation manifold; and
a third phase in which the two groups are first supplied simultaneously, then a purge valve of the evacuation manifold is opened then closed.

6. The method as claimed in claim 5, wherein the cells of the various groups are stacked in an interleaved way in one and the same stack, which is to say that a cell of one group is adjacent a cell of another group in the stack.

7. The method as claimed in claim 5, wherein the two first phases are repeated in a plurality of successive alternations before the third phase is passed to, after which a cycle restarts.

8. The method as claimed in claim 5, wherein N is greater than two and either a single group is supplied during a phase or a plurality, but not all, of the groups are supplied by modifying the composition of the groups supplied during a series of successive phases via a gradual permutation of the supplies, then a purge phase is carried out comprising simultaneously opening all the supplies, immediately followed by a common purge via the purge valve.

9. The method as claimed in claim 8, wherein the series of phases is repeated a plurality of times before the purge phase.

10. The method as claimed in claim 5, wherein the battery is a fuel cell battery and the reactant is hydrogen delivered by the supply manifolds to the anode side of the cells of each group.

11. The fuel cell battery as claimed in claim 2, wherein the supplying means supplies hydrogen to the supply manifolds of the N groups, the manifold of a group communicating with the cells of this group from the anode side.

12. The fuel cell battery as claimed in claim 2, wherein the supplying means supplies oxygen to the supply manifolds of the N groups, the manifold of a group communicating with the cells of this group from the cathode side.

13. The fuel cell battery as claimed in claim 3, wherein the supplying means supplies oxygen to the supply manifolds of the N groups, the manifold of a group communicating with the cells of this group from the cathode side.

14. The method as claimed in claim 6, wherein the two first phases are repeated in a plurality of successive alternations before the third phase is passed to, after which a cycle restarts.

15. The method as claimed in claim 6, wherein N is greater than two and either a single group is supplied during a phase or a plurality, but not all, of the groups are supplied by modifying the composition of the groups supplied during a series of successive phases via a gradual permutation of the supplies, then a purge phase is carried out comprising simultaneously opening all the supplies, immediately followed by a common purge via the purge valve.

16. The method as claimed in claim 7, wherein N is greater than two and either a single group is supplied during a phase or a plurality, but not all, of the groups are supplied by modifying the composition of the groups supplied during a series of successive phases via a gradual permutation of the supplies, then a purge phase is carried out comprising simultaneously opening all the supplies, immediately followed by a common purge via the purge valve.

17. The method as claimed in claim 6, wherein the battery is a fuel cell battery and the reactant is hydrogen delivered by the supply manifolds to the anode side of the cells of each group.

18. The method as claimed in claim 7, wherein the battery is a fuel cell battery and the reactant is hydrogen delivered by the supply manifolds to the anode side of the cells of each group.

19. The method as claimed in claim 8, wherein the battery is a fuel cell battery and the reactant is hydrogen delivered by the supply manifolds to the anode side of the cells of each group.
